(19) United States
(12) Patent Application Publication
(10) Pub. No.: US 2021/0004566 A1
(43) Pub. Date: Jan. 7, 2021

(54) METHOD AND APPARATUS FOR 3D OBJECT BOUNDING FOR 2D IMAGE DATA

(71) Applicant: GM GLOBAL TECHNOLOGY OPERATIONS LLC, Detroit, MI (US)

(72) Inventors: Xuewei Qi, Sterling Heights, MI (US); Andrew J. Lingg, Rochester Hills, MI (US); Mohammed H. Al Qizwini, Macomb, MI (US); David H. Clifford, Royal Oak, MI (US); Daniel R. Wilson, Warren, MI (US); Benjamin J. Cool, Canton, MI (US)

(73) Assignee: GM GLOBAL TECHNOLOGY OPERATIONS LLC, Detroit, MI (US)

(21) Appl. No.: 16/460,015

(22) Filed: Jul. 2, 2019

(51) Int. Cl. G06K 9/00; G06T 7/33; G06T 7/13; G06T 7/60; G06K 9/62

(52) U.S. Cl. CPC G06K 9/00201; G06T 7/33; G06T 7/13; G06T 7/60; G06K 9/6256; G06K 9/6288; G05D 1/0231; G06K 9/00791; G06T 2207/10028; G06T 2207/10004; G06T 2207/30248; G06T 2207/20092; G06K 9/6261

(57) ABSTRACT

Methods and apparatus are provided for 3D object bounding for 2D image data for use in an assisted driving equipped vehicle. In various embodiments, an apparatus includes a camera operative to capture a two dimensional image of a field of view, a lidar operative to generate a point cloud of the field of view, a processor operative to generate a three dimensional representation of the field of view in response to the point cloud, to detect an object within the three dimensional representation, to generate a three dimensional bounding box in response to the object, to project the three dimensional bounding box onto the two dimensional image to generate a labeled two dimensional image, and a vehicle controller to controlling a vehicle in response to the labeled two dimensional image.

### BACKGROUND

The present disclosure relates generally to object detection systems on vehicles equipped with advanced driver assistance systems (ADAS). More specifically, aspects of the present disclosure relate to systems, methods and devices to detect and classifying objects within an image for autonomous driving tasks.

An autonomous vehicle is a vehicle that is capable of sensing its environment and navigating with little or no user input. An autonomous vehicle senses its environment using sensing devices such as radar, lidar, image sensors, and the like. The autonomous vehicle system further uses information from global positioning systems (GPS) technology, navigation systems, vehicle-to-vehicle communication, vehicle-to-infrastructure technology, and/or drive-by-wire systems to navigate the vehicle.

Vehicle automation has been categorized into numerical levels ranging from zero, corresponding to no automation with full human control, to five, corresponding to full automation with no human control. Various automated driver-assistance systems, such as cruise control, adaptive cruise control, and parking assistance systems correspond to lower automation levels, while true “driverless” vehicles correspond to higher automation levels.

Some autonomous vehicles can include systems that use sensor data to classify objects. These systems can identify and classify objects in the surrounding environment including objects located in the vehicle's travel path. In these systems, an entire image obtained from a camera mounted on a vehicle is searched for objects of interest that need to be classified. This approach to object classification is computationally intensive and expensive, which makes it slow and very time consuming and suffers from object detection problems. Human controlled imaged based object detection models require a significant amount of human labeled data for training which may be labor intensive and error prone.

Accordingly, it is desirable to provide systems and methods that can speed up the process of classifying data labeling, training and objects within an image. Furthermore, other desirable features and characteristics of the present invention will become apparent from the subsequent detailed description and the appended claims, taken in conjunction with the accompanying drawings and the foregoing technical field and background.

### SUMMARY

Disclosed herein are object detection methods and systems and related control logic for provisioning vehicle sensing and control systems, methods for making and methods for operating such systems, and motor vehicles equipped with onboard sensor and control systems. Further, disclosed herein are methods and pipelines for generating accurate 3D object labels in images by using 3D information from point cloud data.

In accordance with various embodiments, an apparatus is provided including a camera operative to capture a two dimensional image of a field of view, a lidar operative to generate a point cloud of the field of view, a processor operative to generate a three dimensional representation of the field of view in response to the point cloud, to detect an object within the three dimensional representation, to generate a three dimensional bounding box in response to the object, to project the three dimensional bounding box onto the two dimensional image to generate a labeled two dimensional image, and a vehicle controller to controlling a vehicle in response to the labeled two dimensional image.

In accordance with another aspect, the three dimensional representation of the field of view is a voxelized representation of a three dimensional volume.

In accordance with another aspect of the present invention, the three dimensional bounding box is representative of a centroid, length, width and height of the object.

In accordance with another aspect of the present invention, the processor is further operative to align the image the point cloud in response to an edge detection.

In accordance with another aspect, the processor is further operative to calibrate and co-register a point in the point cloud and a pixel in the image.

In accordance with another aspect, the vehicle controller is operative to execute an adaptive cruise control algorithm.

In accordance with another aspect, the labeled two dimensional image is used to confirm a image based object detection method.

In accordance with another aspect, the object is detected in response to a convolutional neural network.

In accordance with another aspect, a method includes: receiving, via a camera, a two dimensional image, receiving, via a lidar, a point cloud, generating with a processor, a three dimensional space in response to the point cloud, detecting with the processor, an object within the three dimensional space, generating with the processor, a bounding box in response to the object, projecting with the processor, the bounding box into the two dimensional image to generate a labeled two dimensional image, and controlling a vehicle, via a vehicle controller, in response to the labeled two dimensional image.

In accordance with another aspect, the two dimensional image and the point cloud have an overlapping field of view.

In accordance with another aspect, the vehicle is controlled in response to an adaptive cruise control algorithm.

In accordance with another aspect, the wherein the object is detected in response to a convolutional neural network.

In accordance with another aspect, the labeled two dimensional image is labeled with at least one projection of the bounding box and wherein the boxing box is indicative of the detected object.

In accordance with another aspect, the processor is further operative to calibrate and co-register a point in the point cloud and a pixel in the image.

In accordance with another aspect, the processor is further operative to calibrate and co-register a point in the point cloud, a pixel in the image, and a location coordinate received via a global positioning system.

In accordance with another aspect a vehicle control system in a vehicle including a lidar operative to generate a point cloud of a field of view, a camera operative to capture an image of the field of view, a processor operative to generate a three dimensional representation in response to the point cloud and to detect an object within the three dimensional representation, the processor being further operative to generate a bounding box in response to the object and to project the bounding box onto the image to generate a labeled image, and a vehicle controller to control the vehicle in response to the labeled image.

In accordance with another aspect, a memory wherein the processor is operative to store the labeled image in the memory and the vehicle controller is operative to retrieve the labeled image from the memory.

In accordance with another aspect, the three dimensional representation is a voxelized three dimensional representation.

In accordance with another aspect, the labeled image is a two dimensional image having a two dimensional representation of the bounding box overlaid upon the image.

In accordance with another aspect, the labeled image is used to train a visual object detection algorithm.

The above advantage and other advantages and features of the present disclosure will be apparent from the following detailed description of the preferred embodiments when taken in connection with the accompanying drawings.

### BRIEF DESCRIPTION OF THE DRAWINGS

The above-mentioned and other features and advantages of this invention, and the manner of attaining them, will become more apparent and the invention will be better understood by reference to the following description of embodiments of the invention taken in conjunction with the accompanying drawings.

FIG. 1 illustrates an exemplary application of the method and apparatus for three dimensional (3D) object bounding from two-dimensional (2D) image data according to an embodiment of the present disclosure.

FIG. 2 is a block diagram illustrating an exemplary system for 3D object bounding for 2D image data according to an embodiment of the present disclosure.

FIG. 3 is a flowchart illustrating an exemplary method for 3D object bounding for 2D image data according to an embodiment of the present disclosure

FIG. 4 is a block diagram illustrating another exemplary system for 3D object bounding for 2D image data according to an embodiment of the present disclosure.

FIG. 5 is a flowchart illustrating another exemplary method for 3D object bounding for 2D image data according to an embodiment of the present disclosure.

### DETAILED DESCRIPTION

Embodiments of the present disclosure are described herein. It is to be understood, however, that the disclosed embodiments are merely examples and other embodiments can take various and alternative forms. The figures are not necessarily to scale; some features could be exaggerated or minimized to show details of particular components. Therefore, specific structural and functional details disclosed herein are not to be interpreted as limiting, but are merely representative. The various features illustrated and described with reference to any one of the figures can be combined with features illustrated in one or more other figures to produce embodiments that are not explicitly illustrated or described. The combinations of features illustrated provide representative embodiments for typical applications. Various combinations and modifications of the features consistent with the teachings of this disclosure, however, could be desired for particular applications or implementations.

In the presently disclosed exemplary method and system are operative to generate accurate three dimensional (3D) object labels, such as a bounding box, in a two dimensional (2D) image by utilizing point cloud data from a Lidar or other depth sensor system.

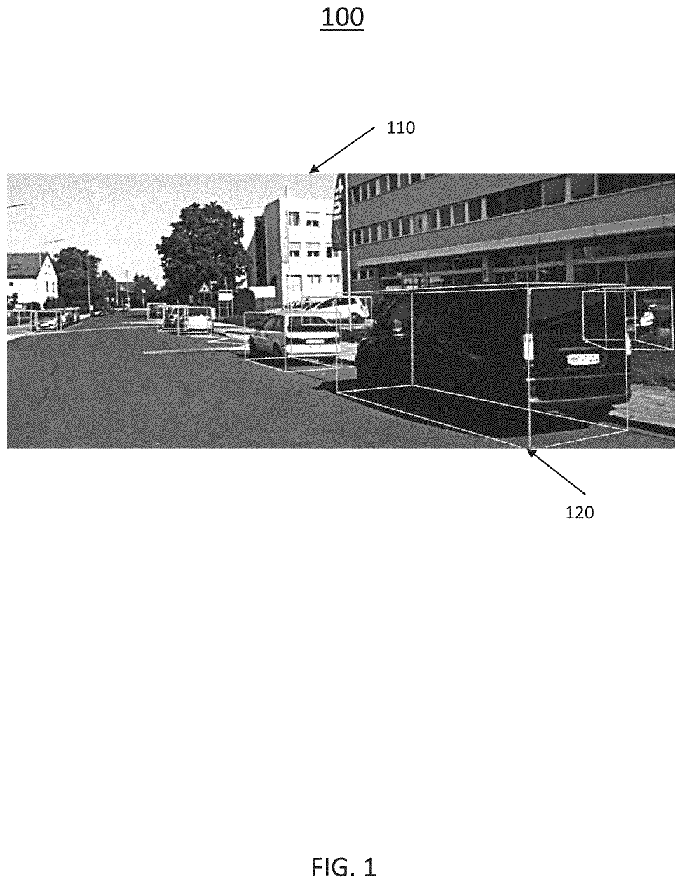

Turning to FIG. 1, an exemplary 2D image data having 3D object boxes 100 for use in ADAS equipped vehicles and for training ADAS vehicle control systems according to an exemplary embodiment of the present disclosure is shown. The exemplary image data is generated in response to a 2D camera capture 110 of a field of view. The image data may be captured from a single camera image or may be a composite image generated from two or more camera images having overlapping fields of view. The image data may be captured by a high resolution camera or a low resolution camera and coupled to a image processor for processing or the image data may be generated by the camera in an image format, such as RAW, containing minimally processed data from the image sensor, or may be in a compressed and processed file format, such as JPEG.

In this exemplary embodiment of the present disclosure, 3D data of the same field of view of the 2D image is received in response to a point cloud output from a lidar sensor. The 3D point cloud is generated by the lidar system generating a laser pulse at a known angle and elevation and receiving a reflection of the laser pulse at a sensor. The distance of the point of reflection of the laser pulse is determined in response to the elapsed time between the transmission and reception of the laser pulse. This process is repeated over a field of view at predetermined angular intervals until a point cloud is generated over the field of view. The point could is then used to detect objects within the field of view and to generate a 3D bounding box 120 around the detected object.

3D object detection in the point cloud is used to predict a 3D bounding box 120 that is tightly bound the object and may include information such as centroid and length, width and height dimensions of that bounding box. The system is then operative to calibrate and co-register the point in the point cloud and the pixels in the image and project the 3D bounding box 120 from point cloud space to image plane.

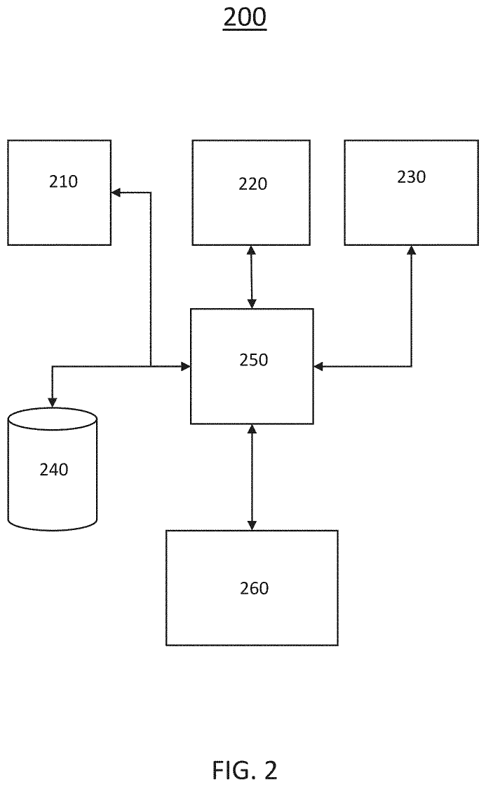

Turning now to FIG. 2, a block diagram illustrating an exemplary system 200 for 3D object bounding for 2D image data is shown. The exemplary system 200 includes a global positioning system 210, a lidar system 220, a camera 230, a processor 250, a memory 240 and a vehicle controller 260. The GPS receiver 210 is operative to receive a plurality of signals indicative of a satellite location and a time stamp. In response to these signals, the GPS receiver 210 is operative to determine a location of the GPS receiver 210. The GPS receiver 210 is then operative to couple this location to the vehicle processor 250. The GPS location information may be used to align an image data and a point cloud data.

The exemplary system is equipped with a plurality of active sensors, such as the lidar system 220, and the camera 230, implemented as part of an adaptive driving assistance system (ADAS). The plurality of active sensors can comprise any suitable arrangement and implementation of sensors. Each of these sensors uses one or more techniques for the sensing of detectable objects within their field of view. These detectable objects are referred to herein as “targets”. The plurality of active sensors may include long range sensors, short range sensors, mid-range sensors, short range sensors, and vehicle blind spot sensors or side sensors. Typically, the range of these sensors is determined by the detection technique employed. Additionally, for some sensor, such as a radar sensor, the range of the sensor is determined by the amount energy being emanated by the sensor, which can be limited by government regulation. The field of view of sensors may also limited by the configuration of the sensing elements themselves, such as by the location of the transmitter and detector.

Typically, sensors are continually sensing, and provide information on any detected targets at a corresponding cycle rate. The various parameters used in determining and reporting the location of these targets will typically vary based on the type and resolution of the sensor. Typically the field of view of the sensors will commonly overlap significantly. Thus, a target near the vehicle may be commonly sensed by more than one sensor each cycle. The systems and methods of the various embodiments facilitate a suitable evaluation of targets sensed by one or more targets.

Typically, the system and method may be implemented by configuring the sensors to provide data to a suitable processing system. The processing system will typically include a processor 250 and memory 240 to store and execute the programs used implement the system. It should be appreciated that these systems may be implemented in connection with and/or as part of other systems and/or other apparatus in the vehicle.

The camera 230 is operative to capture a 2D image or a series of 2D images of a camera field of view. In an exemplary embodiment of the system 200, the field of view of the camera 230 overlaps the field of view of the lidar system 220. The camera is operative to convert the image to an electronic image file and to couple this image file to the processor 250. The image file may be coupled to the vehicle processor 250 continuously, such as a video stream, or may be transmitted in response to a request by the processor 250.

The lidar system 220 is operative to scan a field of view with a plurality of laser pulses in order to generate a point cloud. The point cloud is a data set composed of point data indicating a distance, elevation and azimuth of each point within the field of view. Higher resolution point clouds have a higher concentration of data points per degree of elevation/azimuth but require a longer scan time to collect the increased number of data points. The lidar system 220 is operative to couple the point cloud to the processor 250.

According to the exemplary embodiment, the processor 250 is operative to receive the image file from the camera 230 and the point cloud from the lidar system 220 in order to generate 3D object bounding boxes for objects depicted within the image for use by an ADAS algorithm. The processor 250 is first operative to perform a voxelization process on the point could to generate a 3D voxel based representation of the field of view. A voxel is a value represented in a three dimensional grid, thereby converting the point cloud point data into a three dimensional volume. The processor 250 is then operative to perform a 3D convolution operation on the 3D voxel space in order to represent detected objects within the 3D voxel space. The processor 250 then generates 3D bounding boxes in response to the object detection and performs a 3D geometric projection on to the 2D image. The processor 250 is then operative to generate 3D labels onto the 2D image to identify and label objects within the image. The processor 250 may then be operative to store this labeled 2D image in a memory. The label 2D images is then used to perform an ADAS algorithm in an ASAD equipped vehicle.

The processor 250 may be further operative to perform an ADAS algorithm in addition to other vehicular operations. The vehicle processor 250 is operative to receive GPS location information, image information, in addition to map information stored in the memory 240 to determine an object map of the proximate environment around the vehicle. The vehicle processor 250 runs the ADAS algorithm in response to the received data and operative to generate control signals to couple to the vehicle controller 260 in order to control the operation of the vehicle. The vehicle controller 260 may be operative to receive control signals from the vehicle processor 250 and to control vehicle systems such as steering, throttle, and brakes.

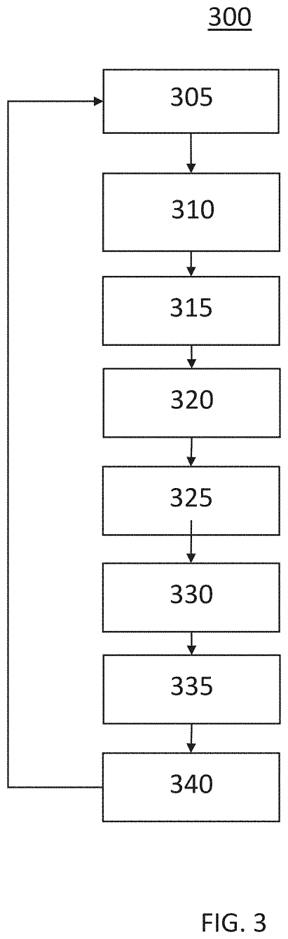

Turning now to FIG. 3, a flow chart illustrating an exemplary method 300 for 3D object bounding for 2D image data is shown. The method 300 is first operative to receive 305 a 2D image from a camera having a field of view. The 2D image may be captured by a single camera, or may be a composite image generated in response to a combination of multiple images from multiple cameras having overlapping fields of view. The image may be in a RAW image format or in a compressed image format, such as JPEG. The image may be coupled to the processor, or stored in a buffer memory for access by the processor.

The method is then operative to receive 310 a lidar point cloud of the field of view. The lidar point cloud is generated in response to a series of transmitted and received light pulses, each transmitted at a known elevation and azimuth. The lidar point cloud may be generated in response to a single lidar transceiver or a plurality of lidar transceivers having overlapping fields of view. In this exemplary embodiment, the lidar point could is substantially overlapping with the image received from the camera. The lidar point cloud represents a matrix of points, wherein each point is associated with a depth determination. Thus, the lidar point cloud is similar to a digital image wherein the color information of a pixel is replaced with a depth measurement determined in response to half the propagation time of the transmitted and reflected light pulse.

The method is then operative to perform 315 a voxelization processes to convert the lidar point could to a three dimensional volume. A voxel is a unit cubic volume centered at a grid point and is analogous to a pixel in a two dimensional image. The dimensions of the unit cubic volume define the resolution of the three dimensional voxelized volume. The smaller the unit cubic volume, the higher the resolution of the three dimensional voxelized volume. Voxelization is sometimes referred to as 3D scan conversion. The voxelization process is operative to generate a three dimensional representation of the location and depth information of the lidar point cloud. In an exemplary embodiment, after the point cloud is first voxelized, the points on the road ground plane may be removed and the other points on the road users such as vehicles and/or pedestrians may be clustered based on the connectivity between the points. For example, all the points on the same vehicle will be marked as the same color. Then the center of each cluster of points may be calculated and the other dimensions (height, width, length) are also calculated. A 3D bounding box may then generated to bound this object in the 3D space. This unsupervised learning model may not require any training data which usually required by supervised learning models like convolutional neural network.

The method is then operative to perform 320 an object detection within the three dimensional voxelized volume. Convolutional neural networks may be used to detect objects within the volume. Once the objects are detected, the method is then operative to bound 325 the detected objects with 3D bounding boxes. The 3D bounding box may tightly bound the object with the information of centroid and length, width and height dimensions of that bounding box. The 3D bounding boxes are then representative of the volumetric space occupied by the object.

The method is then operative to perform 330 a 3D geometric projection of the 3D bounding boxes from the voxelized volume to the 2D image space. The project may be performed in response to a center reprojection along a principle axis onto an image play orthogonal to the principle axis. The method may be operative to calibrate and co-register the point in point cloud and the pixels in image. Then project the 3D bounding box from point cloud space to image plane. The method is then operative to generate 335 object labels in the 2D image representative of the 3D bounding boxes to generate a labeled 2D image.

The method is then operative to control 340 a vehicle in response to the labeled 2D image. The processing of 2D images may be less computationally intense than processing of 3D space and therefore the 2D processing may be performed faster than the 3D processing. For example, the labeled 2D image may then be used for ADAS algorithms such as lane following, adaptive cruise control, etc. The label volumes may then be indications of objects within the proximate spaces to be avoided during potential operations such as lane changes, etc.

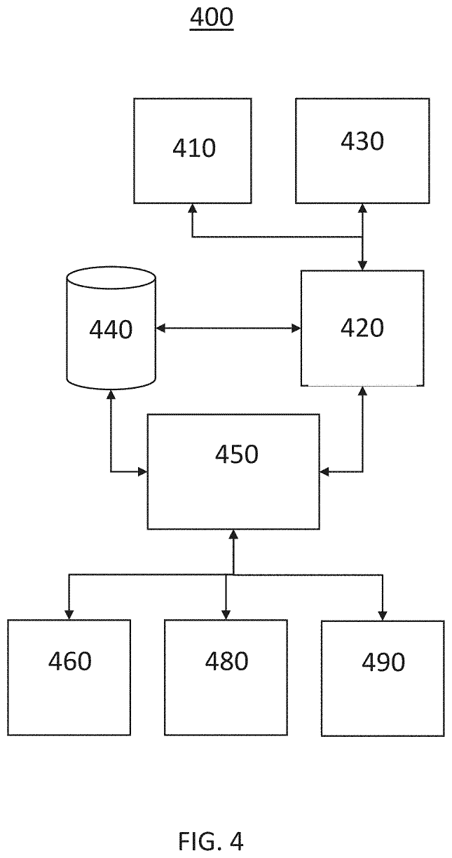

Turning now to FIG. 4 a block diagram illustrating an exemplary system 400 for 3D object bounding for 2D image data is shown. In this exemplary embodiment, the system 400 includes a lidar system 410, a camera 430, a memory 440, a processor 420, a vehicle controller 450, a throttle controller 460, a steering controller 480 and a braking controller 490.

The camera 430 is operative to capture a two dimensional image of a field of view. The field of view may be a forward field of view for a moving vehicle. The camera 430 may be one or more image sensors, each operative to collect image data or a portion of the field of view which may be combined together to generate the image of the field of view. The camera 430 may be a high resolution or low resolution camera operative depending on the application and the required resolution. For example, for a level 5 fully autonomous vehicle, a high resolution camera may be required to facilitate the image detection requirements. In a level 2, lane centering application, a lower resolution camera may be used to maintain a lane centering operation. The camera 430 may be a high dynamic range camera for operation in extreme lighting conditions, such as bright sunlight or dark shadows.

The lidar system 410 may be a lidar transceiver operative to transit a light pulse and receive a reflection of the light pulse from an object within the lidar system 410 field of view. The lidar system 410 is then operative to determine a distance to an object in response to the propagation time of the light pulse. The lidar system 410 is then operative to repeat this operation for a plurality of elevations and azimuths in order to generate a point cloud of the field of view. The resolution of the point cloud is established in response to the number of elevation and azimuth points measured in response to the transmission and reception of light pulses. The resulting point cloud is a matrix of depth values associated for each elevation/azimuth point.

The processor 420 may be a graphics processing unit or central processing unit performing the disclosed image processing operations, a vehicle controller operative to perform ADAS functions, or another system processor operative to perform the presently disclosed methods. The processor 420 is operative to generate a three dimensional representation of the field of view in response to the point cloud received from the lidar system 410. The three dimensional representation maybe a voxelized three dimensional volume representative of the field of view of the camera 430 and the lidar 410. The three dimensional representation may estimate the solid volume of objects within the field of view compensating for occlusions by using occlusion culling techniques and previously generated three dimensional volumes.

The processor 420 is operative to detect and defined an object within the three dimensional representation using convolutional neural network techniques or other technique for processing the three dimensional volume. In response to the object detection, the processor 420 is then operative to generate a three dimensional bounding box around each object detected. The three dimensional bounding box may be representative of a centroid, length, width and height of the object.

The processor 420 is then operative to project the three dimensional bounding box onto the two dimensional image to generate a labeled two dimensional image. The processor 420 may be further operative to align the image the point cloud in response to an edge detection. A geometrical model may be used to spatially align the image and the point cloud followed by a process, such a regression-based resolution matching algorithm to interpolate any occlusions or missing data. The processor 420 is further operative to calibrate and co-register a point in the point cloud and a pixel in the image. The three dimensional bounding boxes may then be geometrically projected onto the image plane to a center of projection originating at the camera 430 and lidar system 410. The processor 420 is then operative to store the labeled two dimensional image to the memory 440, or couple the labeled two dimensional image to the vehicle controller 450.

The vehicle controller 450 is operative to control controlling a vehicle in response to the labeled two dimensional image. The vehicle controller 450 may use the labeled two dimensional image in executing an ADAS algorithm, such as an adaptive cruise control algorithm. The vehicle controller 450 is operative to generate control signals to couple to the throttle controller 460, the steering controller 480 and the braking controller 490 in order to execute the ADAS function.

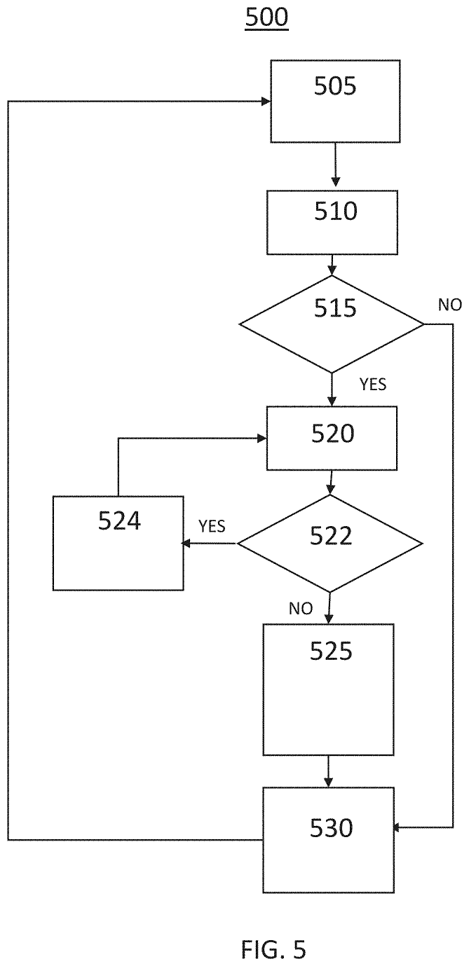

Turning now to FIG. 5, a flow chart illustrating an exemplary method 500 for 3D object bounding for 2D image data is shown. In this exemplary embodiment, the method is first operative to receive 505, via a camera, a two dimensional image representative of a field of view and to receive, via a lidar, a point cloud representative of depth information of the field of view. The method is then operative to generate 510 a three dimensional space in response to the point cloud. The method then operative to detect 515 at least one object within the three dimensional space. If no object is detected, the method is then operative to couple 530 the image to the vehicle controller for use in executing an ASAD algorithm. If an object is detected, the method then generates 520 a three dimensional bounding box around the object within the three dimensional space. The method is may then be operative to receive 522 a user input to refine the three dimensional bounding box. If a user input is receive, the method is operative to refine 524 the 3D bounding box and retrain the three dimensional bounding box algorithm according to the user input. The method is then operative to regenerate 520 the three dimensional bounding box around the object. If no user input is received 522, the three dimensional bounding box is then geometrically projected 525 on to the two dimensional image in order to generate a labeled two dimensional image. The labeled two dimensional image is then used by the vehicle controller to execute 530 an ASAD algorithm. The labeled two dimensional image may be used to confirm the results of a visual object detection method, may be used as a primary data source for object detection, or may be combined with other object detection results.

It should be emphasized that many variations and modifications may be made to the herein-described embodiments, the elements of which are to be understood as being among other acceptable examples. All such modifications and variations are intended to be included herein within the scope of this disclosure and protected by the following claims. Moreover, any of the steps described herein can be performed simultaneously or in an order different from the steps as ordered herein. Moreover, as should be apparent, the features and attributes of the specific embodiments disclosed herein may be combined in different ways to form additional embodiments, all of which fall within the scope of the present disclosure.

Conditional language used herein, such as, among others, “can,” “could,” “might,” “may,” “e.g.,” and the like, unless specifically stated otherwise, or otherwise understood within the context as used, is generally intended to convey that certain embodiments include, while other embodiments do not include, certain features, elements and/or states. Thus, such conditional language is not generally intended to imply that features, elements and/or states are in any way required for one or more embodiments or that one or more embodiments necessarily include logic for deciding, with or without author input or prompting, whether these features, elements and/or states are included or are to be performed in any particular embodiment.

Moreover, the following terminology may have been used herein. The singular forms “a,” “an,” and “the” include plural referents unless the context clearly dictates otherwise. Thus, for example, reference to an item includes reference to one or more items. The term “ones” refers to one, two, or more, and generally applies to the selection of some or all of a quantity. The term “plurality” refers to two or more of an item. The term “about” or “approximately” means that quantities, dimensions, sizes, formulations, parameters, shapes and other characteristics need not be exact, but may be approximated and/or larger or smaller, as desired, reflecting acceptable tolerances, conversion factors, rounding off, measurement error and the like and other factors known to those of skill in the art. The term “substantially” means that the recited characteristic, parameter, or value need not be achieved exactly, but that deviations or variations, including for example, tolerances, measurement error, measurement accuracy limitations and other factors known to those of skill in the art, may occur in amounts that do not preclude the effect the characteristic was intended to provide.

Numerical data may be expressed or presented herein in a range format. It is to be understood that such a range format is used merely for convenience and brevity and thus should be interpreted flexibly to include not only the numerical values explicitly recited as the limits of the range, but also interpreted to include all of the individual numerical values or sub-ranges encompassed within that range as if each numerical value and sub-range is explicitly recited. As an illustration, a numerical range of “about 1 to 5” should be interpreted to include not only the explicitly recited values of about 1 to about 5, but should also be interpreted to also include individual values and sub-ranges within the indicated range. Thus, included in this numerical range are individual values such as 2, 3 and 4 and sub-ranges such as “about 1 to about 3,” “about 2 to about 4” and “about 3 to about 5,” “1 to 3,” “2 to 4,” “3 to 5,” etc. This same principle applies to ranges reciting only one numerical value (e.g., “greater than about 1”) and should apply regardless of the breadth of the range or the characteristics being described. A plurality of items may be presented in a common list for convenience. However, these lists should be construed as though each member of the list is individually identified as a separate and unique member. Thus, no individual member of such list should be construed as a de facto equivalent of any other member of the same list solely based on their presentation in a common group without indications to the contrary. Furthermore, where the terms “and” and “or” are used in conjunction with a list of items, they are to be interpreted broadly, in that any one or more of the listed items may be used alone or in combination with other listed items. The term “alternatively” refers to selection of one of two or more alternatives, and is not intended to limit the selection to only those listed alternatives or to only one of the listed alternatives at a time, unless the context clearly indicates otherwise.

The processes, methods, or algorithms disclosed herein can be deliverable to/implemented by a processing device, controller, or computer, which can include any existing programmable electronic control unit or dedicated electronic control unit. Similarly, the processes, methods, or algorithms can be stored as data and instructions executable by a controller or computer in many forms including, but not limited to, information permanently stored on non-writable storage media such as ROM devices and information alterably stored on writeable storage media such as floppy disks, magnetic tapes, CDs, RAM devices, and other magnetic and optical media. The processes, methods, or algorithms can also be implemented in a software executable object. Alternatively, the processes, methods, or algorithms can be embodied in whole or in part using suitable hardware components, such as Application Specific Integrated Circuits (ASICs), Field-Programmable Gate Arrays (FPGAs), state machines, controllers or other hardware components or devices, or a combination of hardware, software and firmware components. Such example devices may be on-board as part of a vehicle computing system or be located off-board and conduct remote communication with devices on one or more vehicles.

While exemplary embodiments are described above, it is not intended that these embodiments describe all possible forms encompassed by the claims. The words used in the specification are words of description rather than limitation, and it is understood that various changes can be made without departing from the spirit and scope of the disclosure. As previously described, the features of various embodiments can be combined to form further exemplary aspects of the present disclosure that may not be explicitly described or illustrated. While various embodiments could have been described as providing advantages or being preferred over other embodiments or prior art implementations with respect to one or more desired characteristics, those of ordinary skill in the art recognize that one or more features or characteristics can be compromised to achieve desired overall system attributes, which depend on the specific application and implementation. These attributes can include, but are not limited to cost, strength, durability, life cycle cost, marketability, appearance, packaging, size, serviceability, weight, manufacturability, ease of assembly, etc. As such, embodiments described as less desirable than other embodiments or prior art implementations with respect to one or more characteristics are not outside the scope of the disclosure and can be desirable for particular applications.

What is claimed is:

1. An apparatus comprising:
a camera operative to capture a two dimensional image of a field of view;
a lidar operative to generate a point cloud of the field of view;
a processor operative to generate a three dimensional representation of the field of view in response to the point cloud, to detect an object within the three dimensional representation, to generate a three dimensional bounding box in response to the object, to project the three dimensional bounding box onto the two dimensional image to generate a labeled two dimensional image; and
a vehicle controller operative to control a vehicle in response to the labeled two dimensional image.

2. The apparatus of claim 1 wherein the three dimensional representation of the field of view is a voxelized representation of a three dimensional volume.

3. The apparatus of claim 1 wherein the three dimensional bounding box is representative of a centroid, length, width and height of the object.

4. The apparatus of claim 1 wherein the processor is further operative to align the image the point cloud in response to an edge detection.

5. The apparatus of claim 1 wherein the processor is further operative to calibrate and co-register a point in the point cloud and a pixel in the image.

6. The apparatus of claim 1 wherein the vehicle controller is operative to execute an adaptive cruise control algorithm.

7. The apparatus of claim 1 wherein the labeled two dimensional image is used to confirm an image based object detection method.

8. The apparatus of claim 1 further comprising a user input for receiving a user correction to a location of the three dimensional bounding box within the.

9. A method comprising:
receiving, via a camera, a two dimensional image;
receiving, via a lidar, a point cloud;
generating with a processor, a three dimensional space in response to the point cloud;
detecting with the processor, an object within the three dimensional space;
generating with the processor, a bounding box in response to the object;
projecting with the processor, the bounding box into the two dimensional image to generate a labeled two dimensional image; and
controlling a vehicle, via a vehicle controller, in response to the labeled two dimensional image.

10. The method of claim 9 wherein the two dimensional image and the point cloud have an overlapping field of view.

11. The method of claim 9 wherein the vehicle is controlled in response to an adaptive cruise control algorithm.

12. The method of claim 9 the wherein the object is detected in response to a convolutional neural network.

13. The method of claim 9 wherein the labeled two dimensional image is labeled with at least one projection of the bounding box and wherein the boxing box is indicative of the detected object.

14. The method of claim 9 further comprising co-registering a point in the point cloud and a pixel in the image.

15. The method of claim 9 further comprising co-registering a point in the point cloud, a pixel in the image, and a location coordinate received via a global positioning system.

16. A vehicle control system in a vehicle comprising:
a lidar operative to generate a point cloud of a field of view;
a camera operative to capture an image of the field of view;
a processor operative to generate a three dimensional representation in response to the point cloud and to detect an object within the three dimensional representation, the processor being further operative to generate a bounding box in response to the object and to project the bounding box onto the image to generate a labeled image; and
a vehicle controller to control the vehicle in response to the labeled image.

17. The apparatus of claim 16 further comprising a memory wherein the processor is operative to store the labeled image in the memory and the vehicle controller is operative to retrieve the labeled image from the memory.

18. The apparatus of claim 16 wherein the three dimensional representation is a voxelized three dimensional representation.

19. The apparatus of claim 16 wherein the labeled image is a two dimensional image having a two dimensional representation of the bounding box overlaid upon the image.

20. The apparatus of claim 16 wherein the labeled image is used to train a visual object detection algorithm.
